(19) United States
(12) Patent Application Publication
(10) Pub. No.: US 2008/0052621 A1
(43) Pub. Date: Feb. 28, 2008

(54) SYSTEM AND METHODS FOR PROVIDING INTEGRATED SITUATIONAL AWARENESS

(75) Inventors: James C. Oliverio, Gainesville, FL (US); Andrew M. Quay, Gainesville, FL (US)

Correspondence Address: AKERMAN SENTERFITT, P.O. BOX 3188, WEST PALM BEACH, FL, 33402-3188, US

(73) Assignee: UNIVERSITY OF FLORIDA RESEARCH FOUNDATION, INC., Gainesville, FL (US)

(21) Appl. No.: 11/843,390

(22) Filed: Aug. 22, 2007

Related U.S. Application Data
(60) Provisional application No. 60/823,173, filed on Aug. 22, 2006.

(51) Int. Cl. G06F 3/00

(52) U.S. Cl. 715/700

(57) ABSTRACT

An integrated situational awareness system is provided. The system includes an interactive media system having an operator interface, a decision-maker interface, and a correlation system in electronic communication with the interactive media system. The correlation system receives, processes, and integrates data received from a plurality of data sources. The interactive media system and correlation system cooperatively function to enable an operator using the operator interface to initiate a plurality of pre-programmed processes that run until the correlation system detects a pre-specified trigger event. In response to an occurrence of the pre-specified trigger event, the correlation system causes a report to be presented via the interactive media system. Through the operator interface the operator controls presentment of situational awareness data to one or more decision makers and through the decision-maker interface one or more decision maker can specify, demonstrate and make known their questions, wishes and decisions.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention is related to the fields of electronic monitoring and data processing. More particularly, the invention is related to systems and methods for electronically integrating multiple sources of data input so as to provide one or more decision makers with real-time awareness of multiple aspects of a dynamically unfolding situation requiring command decisions.

### BACKGROUND OF THE INVENTION

Many situations in a civil, military, commercial, or public safety context unfold dynamically in an uncertain environment. Such situations—including, for example, natural disasters, military and civil conflicts, and incidents of terrorism—require the deployment and management of a wide variety of different resources in order to bring the situation to a successful conclusion, or at least to mitigate the consequences that can be caused by such incidents.

In the event of a large-scale disaster, for instance, response-and-relief agencies must quickly assess the magnitude and nature of the disaster and must then rapidly deploy personnel and materials to contain the effects of the disaster. Similarly, in cases of civil unrest, military or law enforcement agencies must quickly gain an accurate assessment of the situation as it unfolds and take steps to diffuse the situation notwithstanding the situation's inherent uncertainty.

Typically in such situations, decision makers charged with deploying and managing various resources receive inputs from myriad sources. Such sources include reports by on-site personnel, imagery from live video feeds, aerial reconnaissance, and satellite images. The plethora of data received from a wide array of sources, while necessary for effective decision making, can nonetheless quickly overwhelm the ability of civilian or military personnel to synthesize the data and process it into a form that best serves decision makers facing a rapidly changing situation.

Accordingly, there is a need for a system and methods that can efficiently and effectively receive data from multiple sources, and then synthesize, integrate and fuse that data into a form that can lead to effective and timely decision making. More fundamentally, there is a need for a system and methods by which inputs received from multiple or diverse sources simultaneously can be combined, and with which, the combined input can be utilized to augment a decision maker's situational awareness.

### SUMMARY OF THE INVENTION

One embodiment of the invention is an integrated situational awareness system. The system can include an interactive media system having an operator interface and a decision-maker interface. The system also can include a correlation system in electronic communication with the interactive media system, the correlation system being configured to receive, process, and integrate data received from a plurality of data sources.

Operatively, the interactive media system and correlation system can cooperatively function to allow an operator using the operator interface to initiate a plurality of pre-programmed processes that run until the correlation system detects a pre-specified trigger event. In response to an occurrence of the pre-specified trigger event, the correlation system can cause a report to be presented via the interactive media system, and through the operator interface, the operator can control the presentment of situational awareness data to one or more decision makers. Additionally, one or more decision makers can request and/or obtain information through the decision-maker interface. Through the decision-maker interface, the one or more decision makers can issue a command or directive.

Another embodiment of the invention is an integrated situational awareness system that, in addition to an interactive media system having both an operator interface and a decision-maker interface as well as a correlation system in electronic communication with the interactive media system, also includes a plurality of fixed sensor resources. Each of the fixed sensors can be configured to provide data to the correlation system.

Yet another embodiment of the invention is an integrated situational awareness system that include's a plurality of mobile sensor resources in addition to both an interactive media system having an operator interface and a decision-maker interface and a correlation system. Operatively, the mobile sensors can be configured to provide data to the correlation system.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic diagram of an integrated situational awareness system, according to one embodiment of the invention.

FIG. 2 is a schematic diagram of operation platform that can be integrated into the ISAS system illustrated in FIG. 1.

FIG. 3 is a schematic diagram of an integrated situational awareness system, according to another embodiment of the invention.

FIG. 4 is a schematic diagram of an integrated situational awareness system, according to yet another embodiment of the invention.

FIG. 5 is a simulated exemplary representation of an integrated situational awareness system, according to still another embodiment of the invention.

### DETAILED DESCRIPTION

The present invention provides mechanism for receiving and processing inputs from a variety of sources so as to convey to decision makers a coordinated situational awareness of a dynamic event as the event unfolds in real time. The coordinated situational awareness provided to the decision makers allows them to react swiftly and effectively to the event as it unfolds and to influence the course of the event so that a favorable outcome is achieved or unfavorable consequences are mitigated.

More particularly, the system functions as an integrated situational awareness system (ISAS) that can combine a wide variety of inputs. Inputs can be derived from, for example, audio communications transmitted by on-site personnel, fixed sensors such as cameras or audio monitors, visual images from an unmanned aerial vehicle (UAV) or airplane, satellite imagery, as well as other types of mobile sensors. The ISAS can utilize these inputs to provide a current assessment of a variety of different situations. The ISAS also can use such inputs to simulate proposed responses to the situation so as to provide decision makers with an assessment of what the potential result of a particular decision will be in a given situation.

The ISAS can be utilized in various civil, commercial, military, and public safety contexts. These include large-scale disaster response and relief operations, homeland security operations, and various other operations performed, for example, by federal, regional, state, non-profit, and corporate entities.

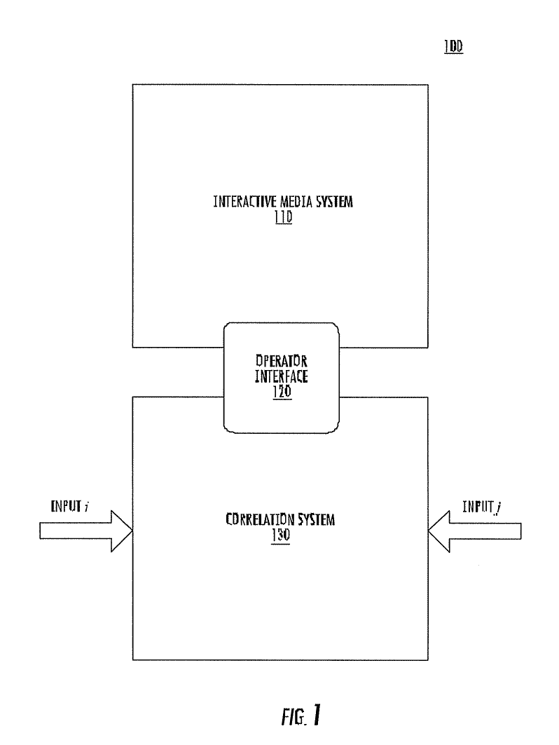

Referring initially to FIG. 1, an ISAS 100 according to one embodiment is schematically illustrated. The ISAS illustratively includes an interactive media system 110 having an operator interface 120. The ISAS further illustratively includes a correlation system 130 in electronic communication with the interactive media system 110. As described herein, the correlation system 130 is configured to receive, process, and integrate data received from a plurality of data sources. Based upon data that is received, processed, and integrated by the correlation system 130, an operator using the operator interface 120 can control the presentment of situational awareness data to one or more decision makers through the interactive media system 110.

One particular aspect of the invention is that the interactive media system 110 and the 130 correlation system cooperatively function to allow the operator, using the operator interface 120, to initiate a plurality of pre-programmed processes. The pre-programmed processes can run until the correlation system 130 detects a pre-specified trigger event. In response to an occurrence of the pre-specified trigger event, the correlation system 130 causes a report to be presented via the interactive media system 110. This is one aspect of the invention that, as described more particularly below, enables the ISAS 100 to reduce for both the operator and for decision makers the cognitive and sensory overloads that can reduce their effectiveness in handling a situation or responding to a crisis in real time.

As further described herein, the ISAS 100 can provide fast and intuitive data mining, data manipulation, data correlation, and situational simulations. This allows the operator to provide decision makers with timely access to useable information. The ISAS 100, as also described herein, provides an integrated platform for augmented decision making in times of crisis when decision makers and others are under physical and mental stress. Decisions, accordingly, can be made based on multiple perspectives of real-time situational awareness. Multiple simulations of potential ramifications of decisions can be rendered before a decision is made so that decision makers are able to better assess the likely outcomes of different decisions.

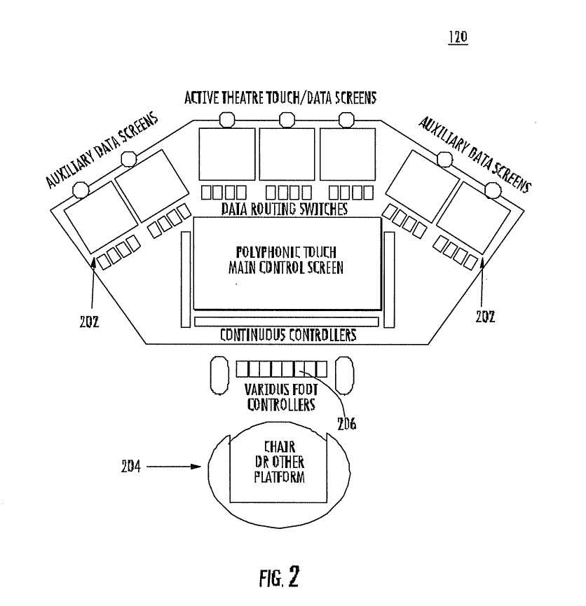

Referring additionally now to FIG. 2, the operator interface 120 can, in one embodiment, comprise a plurality of visual touch screens 202 integrated and synchronized by the correlation system 130 so as to present situational awareness data. The screens 202, according to one embodiment, can be configured to present visual images independently of one another under the control of the operator. As shown, the plurality of visual touch screens 202 can include main control touch screen and several auxiliary screens, including one or more active-theater touch/data screens. Each of the screens 202 can function independently, thereby allowing the operator to simultaneously interact with all of the screens individually. Although each touch screen can respond independently to operator or other input, the screens are preferably integrated and synchronized.

Each of the screens 202, moreover, is preferably configured to respond to a plurality of operator gestures in order to provide complex presentations of situational awareness data. An operator or other user can translate, scale, rotate, select, or correlate data from one screen to another. The main screen can be positioned in front of the operator so that the operator can independently interact through inputs, but nonetheless the display data can be synchronous with the totality of the system. The operator can simultaneously use one or more fingers to interact with the data presented on a screen. Each of the auxiliary screens 202 additionally can support one-finger gestures for data interaction, while the main screen can support gestures composed of one or more fingers to thereby allow more complex interactions with the data.

The screens 202 can form part of a console that includes a chair 204 or other platform in which the operator can be positioned for interacting with the screens. Positioned at the foot of the chair 204 or other platform can be one or more operator foot controllers, such as one or more pedals. In particular, a series of foot pedals 206 (both binary and scalar) can be positioned in front of the operator to allow further modification of finger gestures or concatenation of operator-supplied instructions to the system.

The operator and/or the decision-maker interface 120 can be augmented by physiological or biometric sensors (not explicitly shown), such as nano-scaled physiological sensors. For example, if the operator interface 120 comprises a chair and console configuration as described in the preceding paragraphs, the physiological sensors can be attached to the chair. The sensors can include, for example, a head sensor, heart and vital signs sensors, spinal sensors, and skin monitors that can sense the physiological condition of the operator.

The sensors can provide biometric data to the correlation system 130, which based on the supplied data can determine whether the operator and/or decision maker is at risk of suffering a cognitive and/or sensory overload condition. If so, then the correlation system 130 can respond by eliminating one or more tasks under the operator's control. After a “calming down” period, or when the sensors register an improvement in the operator's condition, the correlation system 130 can introduce, at a desired pace, new tasks that are subject to the operator's control. The correlation system 130 also can, in response to the risk of an operator's and/or decision maker's cognitive or sensory overload, initiate one or more predetermined task management algorithms. The algorithms can carryout processes without the need for interaction with the operator.

The correlation system 130 can comprise various logic-based processing components (not explicitly shown), such as logic gates and registers, for performing various data processing tasks. In particular the correlation system can comprise dedicated circuitry and/or application-specific software code for implementing various modules and/or engines. One such engine can be an alpha-numeric engine for processing character and/or numeric data. Another such engine can be an audio-rendering engine for producing audible output based upon received data. Alternatively, or additionally, the correlation system 130 can also include an interactive voice response module and/or a text-to-speech module for converting between non-audio and audio inputs and outputs.

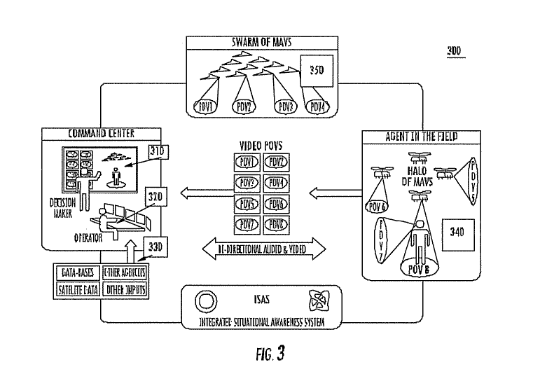

FIG. 3 schematically illustrates another embodiment of an ISAS 300. As illustrated, the ISAS 300 includes an interactive media system 310, operator interface 320, and correlation system 330 located within a command center. One or more agents are located in the field 340, remote from the command center. Each agent can provide real-time information to an operator located in the command center. The operator can then provide a decision maker with real-time data, as requested or required as a situation unfolds. The agent or agents, moreover, can be accompanied by a plurality of mobile vehicles, such as micro-aerial vehicles (MAVs) 340. A plurality of MAVs 340 is referred to herein as a “Halo.” Each Halo can be controlled by the agent in the field and/or the operator in the command center. The agents and/or operator further can control a plurality of MAVs 350, referred to herein as a “swarm.” Each MAV in a swarm 350 is able to carry out a variety of sensing functions so as to augment the input data provided to the ISAS 300 and to thereby enhance the decision maker's situational awareness.

According to one embodiment, one or more mobile interfaces can be integrated with or contained as a subsystem within the operator interface 320 for facilitating communications between the ISAS 300 and any of the various types of field agents or units. The field interface, as well as the operator and decision-maker interfaces, can be utilized by the operator or decision maker for assigning mission tasks to the various field units and/or vehicles performing various sensing functions. For example, a mobile vehicle performing a sensing function can receive a task that specifies a particular path, point of interest, or area that is to be sensed. Moreover, the various types of interfaces that can be provided by ISAS can be used to share operator data with other operators, decision makers, and various field agents or units.

Additionally, any of the various user interfaces can be configured so as to add or remove layers of merged data. For example, in a visual presentation presented on the operator interface 320 or other interface, images captured with a camera sensor can be hidden from view.

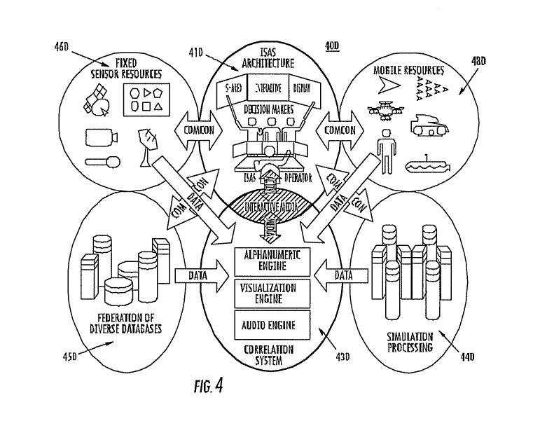

FIG. 4 schematically illustrates an ISAS 400, according to still another embodiment of the invention. The system 400 illustratively includes a simulation processor 440 that, based on received data, can simulate likely outcomes of actions proposed by a decision maker. The simulations can be provided to a correlation system 430 and then presented to one or more decision makers via an interactive media system 410, both the correlation and interactive media systems being of the types already described. Illustratively, the correlation system 430 includes an alphanumeric engine for processing alphanumeric data as well as a visualization engine and an audio engine for generating, respectively, visual images and audio output based upon received data inputs. The system 400 further illustratively includes a federation of databases 450 for providing additional data to the correlation system.

Operatively, the visualization engine illustratively contained within the correlation system 430 can input data from multiple source formats and create new graphical elements that can be separated into diverse layers. For example, a database containing information about a building can be read by the system, visualized into graphical shapes representing the data in the data table, and then separated into component 3D objects. These objects may be viewed as composite entities, or separated into layers. The attributes of the visual representation of said 3D objects and/or layers can be determined by the system operator.

Additionally, for example, an alpha-numeric data table describing the constituent components of a building (e.g., walls, windows, doors, electrical system and receptacle locations, and other structural elements) can be parsed by the system. The correlation system 430 operating in conjunction with the visualization engine thus can produce a three-dimensional (3D) representation of the building data as well as presenting one or more types of corresponding sensor data. The operator, accordingly, can view the outside of the building, or any combination of the interior floors, rooms or constructed components described in the data table. The entire structure can also be used as a layer that optionally can be superimposed upon other layers for purposes of comparison, evaluation, planning or other uses as determined by the operator and/or decision maker. An operator's views can also include static and dynamic data changing in real-time (e.g., temperature data) with all data merged in one view.

As also illustrated, data can be provided to the correlation system 430 from fixed and/or mobile sensing resources 460, 480. The fixed sensing resources 460 can include, for example, one or more satellites that communicate with the ISAS 400 through a ground station, one or more cameras, and/or one or more audio receivers. The mobile sensing resources 480 can include, for example, tracked ground vehicles, underwater vehicles, and airborne vehicles. The airborne vehicles can include Halos or swarms of MAVs, as described above, or UAVs.

The fixed and/or mobile sensing resources 460, 480 can provide data to the correlation system 430. Moreover, the fixed and/or mobile sensing resources 460, 480 can include various types of sensors that can be independently configured to trigger alerts or processes. For example, a camera sensor can be configured to trigger an operator alert in response to detected motion or in response to a detected object exhibiting a predetermined characteristic, such as an object traveling above a pre-specified average velocity (e.g., a human running). Similarly, a chemical sensor can be configured to trigger a process in response to detecting a pre-specified fluid or gas (e.g., a harmful gas or airborne toxin). So, too, for example, an audio sensor can be configured to trigger the operation of one of a plurality of location-specific video cameras in response to detecting the sound of a gun firing in the vicinity of a particular one of the video cameras.

With respect to mobile sensors, the ISAS 400 can track their location and orientation using an electronic tracking system (not explicitly shown) that provides data input to the correlation system 430. Accordingly, the interactive media system 410 of the ISAS 400 can be used to display in real-time, or alternatively, in response to an operator command to recall stored data, the location and orientation of one or more mobile sensors. With respect to both fixed and mobile sensors, the ISAS 400 permits sensor data to be accessed in real-time or be electronically stored for subsequent examination and analysis.

Further with respect to mobile sensors, the ISAS 400 sensors can be configured to respond to mission directions issued by the ISAS 400 in an optimal manner or with corrections. For example, if an operator using the ISAS 400 directs a robot to turn too rapidly, the robot can be configured to respond by suggesting an alternate course. Similarly, if an operator directs a UAV to scan a building, the UAV can be configured to respond by indicating the optimal path to the building and the best path for targeting the UAV's sensor at the building. Additionally, the mobile sensors can be configured to respond to a direction cooperatively with each of the other sensors, or alternatively, each mobile sensor can be configured to respond independently of the other sensors.

Moreover, with the ISAS 400, various sets and subsets of archived data collected through multiple sensors can be culled by the correlation system 430 to predict the relevance of particular data among different sensors. For example, if viewing stored camera images of a vehicle moving along a roadway, the correlation system 430 can cull images obtained with a camera located further away if the vehicle has not yet had time to travel from one camera location to another. Likewise, for example, audio recordings obtained through an audio sensor can be culled in order to identify only those portions of the recordings that were obtained after an acoustic or chemical sensor has detected an explosion.

According to another embodiment, the correlation system 430 and interactive media system 410 can communicate through and with each of the fixed and/or mobile sensing resources 460, 480. The aggregate data provided from these sensing resources, as well as the federation of databases 450 and simulating simulation processor 440 further augment the situational awareness the ISAS 400 provides to decision makers in a dynamically changing situation.

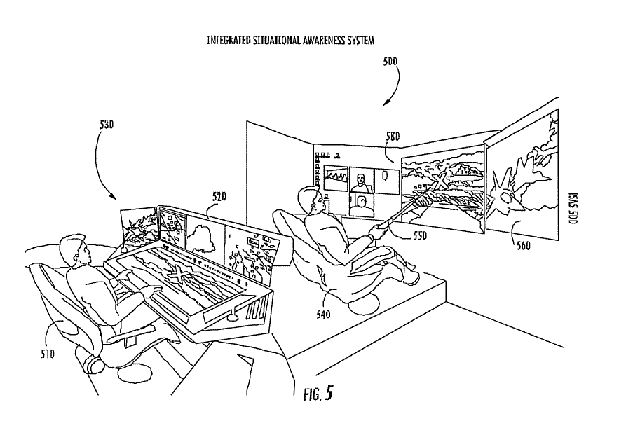

FIG. 5 illustrates an ISAS 500, according to yet another embodiment of the invention. The system 500 illustratively includes a device, defined herein as an operator Aware Chair 510, in which an operator can be seated. The system 500 further illustratively includes another device, defined herein as a decision-maker Aware Chair 540, in which a decision maker can be seated. Various physiological and biometric sensors (not explicitly shown) are embedded in one or both of the operator Aware Chair 510 and the decision-maker Aware Chair 540 to provide ongoing bio-feedback, as already described. Optionally, additional physiological and biometric sensors can be embedded in other platforms utilized by the operator, decision maker, and/or other personnel to also provide ongoing bio-feedback. The ISAS 500 also illustratively includes an ISAS console 520. The ISAS console 520 cooperatively functions with the operator Aware Chair, the ISAS console 520 and operator Aware Chair jointly defining an operator interface 530. Additionally, the ISAS 500 illustratively includes an interactive light emitter 550 and a real-time graphical interactive display 560, that function in synchrony with one another. The interactive light emitter 550, real-time graphical interactive display 560, decision maker Aware Chair 540 jointly comprise a decision maker's interface 580.

In addition, correlation and interactive media systems of the types already described can be included in the system 500. The various configurations described provide distinct advantages, including enabling one or more decision makers to specify, demonstrate, and/or convey and make known their questions, instructions and directives, and/or decisions through the use of a special interactive light emitter 550 operating in synchrony with a real-time graphical display 560, which is also synchronized and correlated with the operator interface 530.

The invention can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention can be embedded in a computer program product, or more particularly, a computer-readable storage medium in which a computer program can be loaded such that when loaded in a computer system causes the computer system to carry out the procedures described herein. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. An integrated situational awareness system, the system comprising
an interactive media system having an operator interface and a decision-maker interface; and
a correlation system in electronic communication with said interactive media system, said correlation system configured to receive, process, and integrate data received from a plurality of data sources;
wherein said interactive media system and correlation system cooperatively function to allow an operator using said operator interface to initiate a plurality of pre-programmed processes that run until said correlation system detects a pre-specified trigger event, wherein, in response to an occurrence of the pre-specified trigger event, the correlation system causes a report to be presented via the interactive media system, and wherein through said operator interface the operator controls presentment of situational awareness data to one or more decision makers, and wherein through said decision-maker interface the one or more decision makers can perform at least one of request and/or obtain information and issue a command and/or directive.

2. The system of claim 1, wherein said operator interface comprises a plurality of visual touch screens integrated and synchronized by the correlation system to present situational awareness data and configured to present visual images independently of one another under the control of the operator.

3. The system of claim 2, wherein each of the plurality of visual touch screens is configured to respond to a plurality of operator gestures to provide complex presentations of situational awareness data.

4. The system of claim 2, wherein said operator interface further comprises at least one operator foot petal for controlling the presentment of visual images with at least one of the plurality of visual touch screens.

5. The system of claim 2, wherein at least one of said operator interface and decision-maker interface contains a plurality of physiological sensors to sense at least one physiological condition of the operator and/or decision maker and provide to said correlation system biometric data based on the at least one physiological condition.

6. The system of claim 5, wherein, in response to said biometric data indicating that at least one of the operator and decision maker is at risk of suffering at least one of a cognitive overload condition and a sensory overload condition, said correlation system initiates a predetermined task management algorithm.

7. The system of claim 1, wherein said correlation system further comprises an alpha-numeric engine.

8. The system of claim 1, wherein said correlation system further comprises a visualization engine.

9. The system of claim 1, wherein said correlation system further comprises an audio-rendering engine.

10. The system of claim 1, further comprising a plurality of a federation of diverse databases in communication with said correlation system for storing diverse data that is provided to said correlation system in response to a data request.

11. The system of claim 1, further comprising a simulation processing system for presenting a simulated result of a decision made by the one or more decision makers in a specified situation.

12. An integrated situational awareness system, the system comprising
an interactive media system having both an operator interface and a decision-maker interface;
a correlation system in electronic communication with said interactive media system, said correlation system configured to receive, process, and integrate data received from a plurality of data sources; and
a plurality of fixed sensor resources for providing data to said correlation system;
wherein said interactive media system and correlation system cooperatively function to allow an operator using said operator interface to initiate a plurality of pre-programmed processes that run until said correlation system detects a pre-specified trigger event, wherein, in response to an occurrence of the pre-specified trigger event, the correlation system causes a report to be presented via the interactive media system, and wherein through said operator interface the operator controls presentment of situational awareness data to one or more decision makers, and wherein through said decision-maker interface the one or more decision makers can perform at least one of request and/or obtain information and issue a command and/or directive.

13. The system of claim 12, wherein said operator interface comprises a plurality of visual touch screens integrated and synchronized by the correlation system to present situational awareness data and configured to present visual images independently of one another under the control of the operator.

14. The system of claim 13, wherein each of the plurality of visual touch screens is configured to respond to a plurality of operator gestures to provide complex presentations of situational awareness data.

15. The system of claim 13, wherein said operator interface further comprises at least one operator foot pedal for controlling the presentment of visual images with at least one of the plurality of visual touch screens.

16. The system of claim 13, wherein at least one of said operator interface and decision-maker interface consists of a plurality of physiological sensors to sense at least one physiological condition of the operator and/or decision maker and provide to said correlation system biometric data based on the at least one physiological condition.

17. The system of claim 16, wherein, in response to said biometric data indicating that the operator and/or decision maker is at risk of suffering at least one of a cognitive overload condition and a sensory overload condition, said correlation system initiates a predetermined task management algorithm.

18. The system of claim 12, wherein said correlation system further comprises an alpha-numeric engine.

19. The system of claim 12, wherein said correlation system further comprises a visualization engine.

20. The system of claim 12, wherein said correlation system further comprises an audio-rendering engine.

21. The system of claim 12, further comprising a plurality of a federation of diverse databases in communication with said correlation system for storing diverse data that is provided to said correlation system in response to a data request.

22. The system of claim 12, further comprising a simulation processing system for presenting a simulated result of a decision made by the one or more decision makers in a specified situation.

23. The system of claim 12, wherein the plurality of fixed sensor resources comprises at least one of a pre-positioned camera, a pre-positioned microphone, or a satellite.

24. An integrated situational awareness system, the system comprising
an interactive media system having an operator interface and a decision-maker interface;
a correlation system in electronic communication with said interactive media system, said correlation system configured to receive, process, and integrate data received from a plurality of data sources; and
a plurality of mobile sensor resources for providing data to said correlation system;
wherein said interactive media system and correlation system cooperatively function to allow an operator using said operator interface to initiate a plurality of pre-programmed processes that run until said correlation system detects a pre-specified trigger event, wherein, in response to an occurrence of the pre-specified trigger event, the correlation system causes a report to be presented via the interactive media system, and wherein through said operator interface the operator controls presentment of situational awareness data to one or more decision makers, and wherein through said decision-maker interface the one or more decision makers can perform at least one of request and/or obtain information and issue a command and/or directive.

25. The system of claim 24, wherein said operator interface comprises a plurality of visual touch screens integrated and synchronized by the correlation system to present situational awareness data and configured to present visual images independently of one another under the control of the operator.

26. The system of claim 25, wherein each of the plurality of visual touch screens is configured to respond to a plurality of operator gestures to provide complex presentations of situational awareness data.

27. The system of claim 25, wherein said operator interface further comprises at least one operator foot pedal for controlling the presentment of visual images with at least one of the plurality of visual touch screens.

28. The system of claim 25, wherein said operator interface comprises a plurality of physiological sensors for sensing at least one physiological condition of the operator and providing to said correlation system biometric data based on the at least one physiological condition.

29. The system of claim 28, wherein, in response to said biometric data indicating that the operator and/or decision maker is at risk of suffering at least one of a cognitive overload condition and a sensory overload condition, said correlation system initiates a predetermined task management algorithm.

30. The system of claim 25, wherein said correlation system further comprises an alpha-numeric engine.

31. The system of claim 24, wherein said correlation system further comprises a visualization engine.

32. The system of claim 24, wherein said correlation system further comprises an audio-rendering engine.

33. The system of claim 24, further comprising a plurality of a federation of diverse databases in communication with said correlation system for storing diverse data that is provided to said correlation system in response to a data request.

34. The system of claim 24, further comprising a simulation processing system for presenting a simulated result of a decision made by the one or more decision makers in a specified situation.

35. The system of claim 24, wherein the plurality of fixed sensor resources comprises at least one of a pre-positioned camera, a pre-positioned microphone, or a satellite.
